(19) United States
(12) Patent Application Publication
(10) Pub. No.: US 2008/0129487 A1
(43) Pub. Date: Jun. 5, 2008

(54) SYSTEM AND METHOD FOR MANAGING CHARACTERISTICS OF A DOMAIN OCCUPIED BY INDIVIDUALS

(75) Inventor: Kevin M. CRUCS, Copley, OH (US)

Correspondence Address: HAHN LOESER & PARKS, LLP, One GOJO Plaza, Suite 300, AKRON, OH, 44311-1076, US

(73) Assignee: CRUCS HOLDINGS, LLC, Copley, OH (US)

(21) Appl. No.: 11/564,926

(22) Filed: Nov. 30, 2006

(51) Int. Cl. G08B 1/08; H04Q 5/22

(52) U.S. Cl. 340/539.13; 340/10.42

(57) ABSTRACT

A system and method for managing at least one characteristic of a domain occupied by individuals. Each of a plurality of individuals is tracked in real time with respect to location within the domain by periodically or continuously acquiring location information for each of the individuals. The acquired location information and resultant tracking information may be used to identify traffic patterns of the individuals within the domain and/or to identify clusters of individuals within the domain. The identified traffic patterns and/or clusters may be used to adapt at least one managed characteristic of the domain. Furthermore, the resultant tracking information may be used to estimate waiting times for events within the domain and/or provide signals or messages to individuals within the domain.

### TECHNICAL FIELD

Certain embodiments of the present invention relate to managing characteristics of a domain occupied by individuals. More particularly, certain embodiments of the present invention relate to a system and method for managing various characteristic aspects of a domain using information obtained from tracking the location of individuals within the domain in real time.

### BACKGROUND OF THE INVENTION

Various systems and methods have been proposed for helping to manage various aspects of, for example, a theme park. Also, various systems and methods have been proposed for tracking the location of individuals.

U.S. Pat. No. 7,047,205 describes a method and system for the loading of patrons at multiple attractions at an entertainment environment which includes the first-in first-out line and a priority based line. A cellular telephone is used to obtain and claim priority status. In other forms, different priorities are established based on where, when and the number of priority spaces required. Different hierarchies are established for computer controlling the different lines for multiple attractions in the entertainment environment. The system and method also provide for moving people from an area of concentration to other locations.

Published U.S. Patent Application No. 2002/0107720 describes a system and method for producing guest demand forecasts that keep pace with the dynamic nature of an amusement park's operating environment, and are prepared in a statistically valid and efficient manner.

U.S. Pat. No. 6,243,039 describes a system that tracks the current and historical locations of a GPS locator device carried by a person and provides widely available access to data referencing these locations, so that a parent can easily and frequently monitor the location of a child.

U.S. Pat. No. 6,833,811 describes a method and system for tracking an object by generating GPS coordinates for the object and a bearing associated with a movement of the object.

U.S. Pat. No. 7,076,441 describes a method and system for identifying and tracking persons using RFID-tagged items carried on the persons.

U.S. Pat. No. 7,043,754 describes a universal lightweight, easily carried memory identification card that records information and controls access to the information. The memory identification card can also have a single chip GPS device to identify where the card is being used.

U.S. Pat. No. 6,999,779 describes a position information management system in which a portable remote terminal includes a plurality of kinds of positioning means for positioning based on a GPS, positioning based on a portable telephone or PHS base station, positioning based on a radio marker, and independent positioning based on a direction detector, so that the holder of the portable remote terminal can be navigated anywhere.

U.S. Pat. No. 6,959,259 describes determining performance data during activity of a person. A microprocessor and a sensor, such as a GPS sensor, attach to the person or to a vehicle ridden by the person. The sensor and microprocessor may integrate in clothing or in a watch worn by the person.

Further limitations and disadvantages of conventional, traditional, and proposed approaches will become apparent to one of skill in the art, through comparison of such systems and methods with the present invention as set forth in the remainder of the present application with reference to the drawings.

### BRIEF SUMMARY OF THE INVENTION

An embodiment of the present invention comprises a method of managing at least one characteristic of a domain occupied by individuals. The method includes tracking each of a plurality of individuals in real time with respect to location, as the individuals move about the domain, by acquiring location information for each of the individuals. The method further includes identifying traffic patterns created by the plurality of tracked individuals within the domain in response to the location information. The method also includes correlating each of the identified traffic patterns to a time-of-day and adapting at least one managed characteristic of the domain in response to at least one of the correlated traffic patterns.

Another embodiment of the present invention comprises a method of managing at least one characteristic of a domain occupied by individuals. The method includes tracking each of a plurality of individuals in real time with respect to location, as the individuals move about within a domain, by acquiring location information for each of the individuals. The method further includes correlating each of the tracked individuals to corresponding age information of each of the tracked individuals in response to the location information. The method also includes identifying at least one cluster of a subset of the tracked individuals within the domain according to an age group in response to the location information and the correlated age information. The method further includes adapting at least one managed characteristic of the domain in response to the at least one identified cluster.

A further embodiment of the present invention comprises a method of managing at least one characteristic of a domain occupied by individuals. The method includes tracking each of a plurality of individuals in real time with respect to location, as the individuals move about within the domain, by acquiring location information for each of the individuals. The method further includes correlating at least one subset of the plurality of tracked individuals to an event location within the domain and to a time-of-day in response to the location information in order to identify at least one cluster of individuals. The method also includes estimating at least one waiting time for the event location in response to the identified cluster.

Still another embodiment of the present invention comprises a method of managing at least one characteristic of a domain occupied by individuals. The method includes tracking at least two individuals in real time with respect to location, as the individuals move about within a domain, by acquiring location information for each of the individuals. The method further includes determining when the at least two individuals are at least a pre-defined distance from each other in response to the location information and generating a signal or message in response to the determining.

These and other advantages and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a flowchart of a first embodiment of a method of managing at least one characteristic of a domain occupied by individuals, in accordance with various aspects of the present invention.

FIG. 2 is a diagram illustrating an exemplary layout of a domain having a plurality of RFID scanners located throughout the domain, in accordance with an embodiment of the present invention.

FIG. 3 is the diagram of FIG. 2 additionally illustrating exemplary identified traffic patterns of individuals, in accordance with the method of FIG. 1.

FIG. 4 is a flowchart of a second embodiment of a method of managing at least one characteristic of a domain occupied by individuals, in accordance with various aspects of the present invention.

FIG. 5 is the diagram of FIG. 2 additionally illustrating exemplary identified clusters of individuals based on age, in accordance with the method of FIG. 4.

FIG. 6 is a flowchart of a third embodiment of a method of managing at least one characteristic of a domain occupied by individuals, in accordance with various aspects of the present invention.

FIG. 7 is a flowchart of a fourth embodiment of a method of managing at least one characteristic of a domain occupied by individuals, in accordance with various aspects of the present invention.

FIG. 8 is the diagram of FIG. 2 additionally illustrating exemplary spatially proximate and spatially remote individuals, in accordance with the method of FIG. 7.

### DETAILED DESCRIPTION OF THE INVENTION

As used herein, the term “individual” means a single person, and “a plurality of individuals” means at least two persons. As used herein, the term “domain” refers to any defined area or region that may be occupied by more than one individual and in which the more than one individual can move about (e.g. a theme park, an amusement park, a fair, a concert, a sports venue, a sports arena, etc.). As used herein, the term “location” refers to a particular area within a domain. As used herein, the term “location information” refers to any data that is used to identify a particular area within a domain. As used herein, the term “tracking” means monitoring within a domain as a function of time and generating tracking information (e.g., a historical path of location of an individual vs. time). As used herein, the term “cluster” refers to a spatially grouped subset of a plurality of individuals within a domain. As used herein, the term “age group” refers to a contiguous range of ages of individuals (e.g., 13 years of age to 23 years of age). As used herein, the term “alert” refers to any indicator (e.g., an audible sound, a flashing light, a vibration) that serves to make an individual aware of an event that has occurred. As used herein, the term “traffic pattern” refers to a dominant path of movement of individuals within a domain. As used herein, the term “event location” refers to the area or position of any event or attraction within the domain.

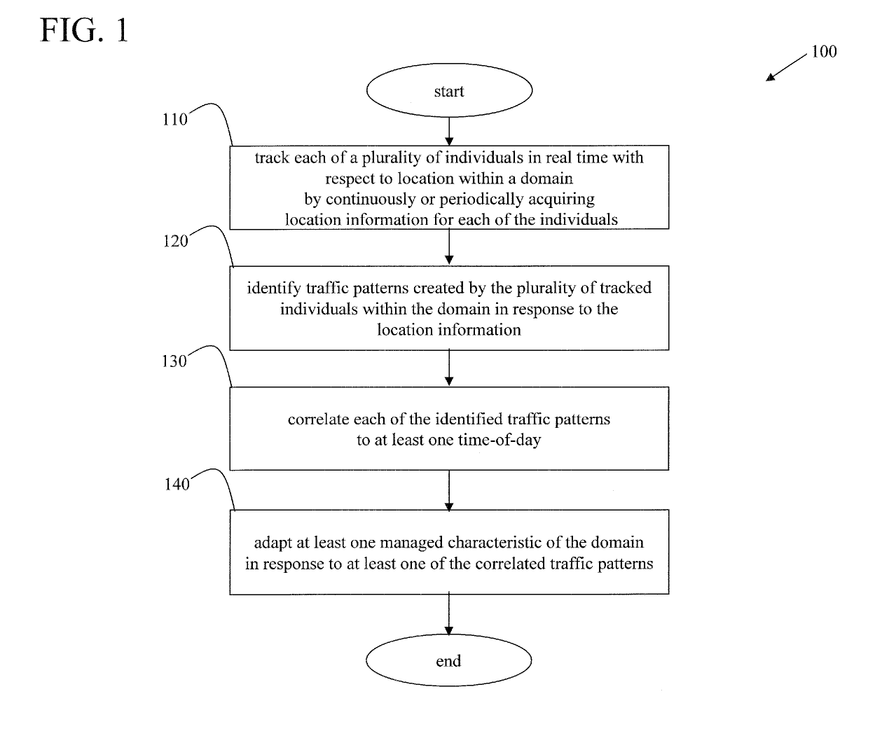

FIG. 1 is a flowchart of a first embodiment of a method 100 of managing at least one characteristic of a domain occupied by individuals, in accordance with various aspects of the present invention. In step 110, each of a plurality of individuals is tracked in real time with respect to location within a domain by continuously or periodically acquiring location information for each of the individuals. In step 120, traffic patterns created by the plurality of tracked individuals within the domain are identified in response to the location information. In step 130, each of the identified traffic patterns are correlated to at least one time-of-day. In step 140, at least one managed characteristic of the domain is adapted in response to at least one of the correlated traffic patterns.

Radio frequency identification (RFID) technology and global positioning system (GPS) technology are well known in the art and may be used, at least in part, to accomplish the locating and tracking functionality described herein. Other positioning technologies are also well known, such as radio marker and direction detection technologies. Any positioning and tracking technology may be used in accordance with various embodiments of the present invention.

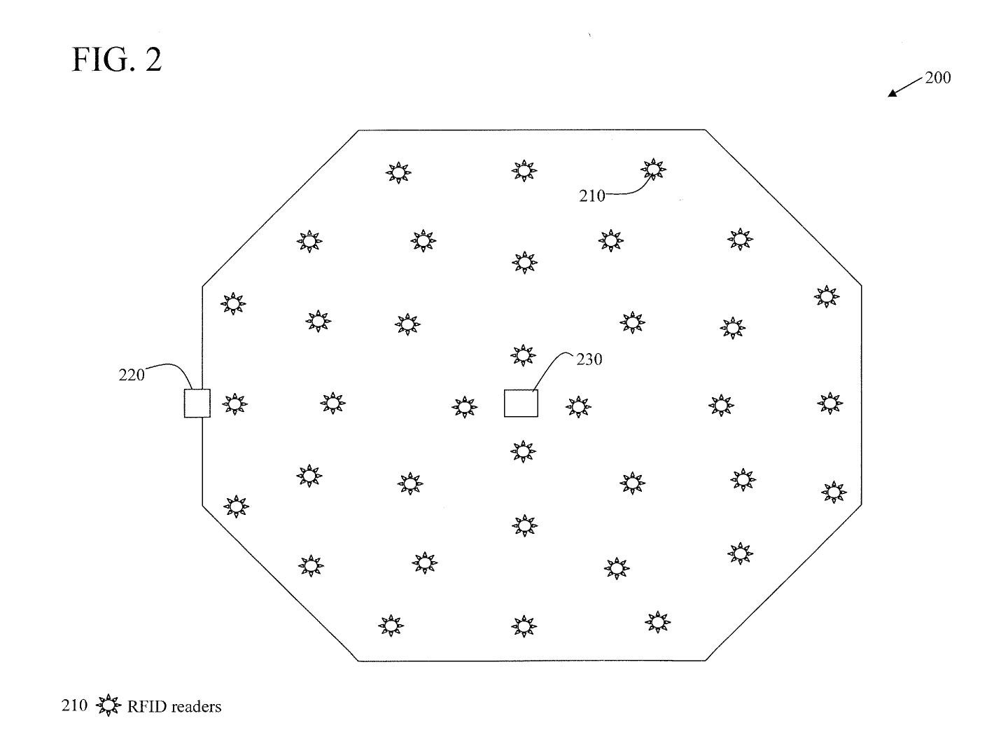

As an example, FIG. 2 is a diagram illustrating an exemplary layout of a domain 200 having a plurality of RFID scanners 210 located throughout the domain 200, in accordance with an embodiment of the present invention. The domain 200 includes at least one entrance/exit 220 through which individuals may enter and/or exit the domain, and a central processing station 230. The domain may comprise, for example, a theme park having rides, concessions, and other features and attractions typically found in a theme park, and the plurality of individuals may be guests in the theme park. Some other examples of domains include amusement parks and shopping malls.

The RFID scanners 210 are used to interrogate RFID tags that are in proximity to the RFID scanners 210 and to receive information encoded on the RFID tags. The received information is then sent to the central processing station 230. In accordance with an embodiment of the present invention, an RFID tag is co-located with an individual. For example, each individual who enters the domain 200 may be given a wrist band having an RFID tag. The RFID tag is encoded with an identifier code which is unique to the individual. As an individual moves about the domain 200 and comes in proximity to an RFID scanner 210, the RFID scanner reads the identifier code from the individual's RFID tag and sends that identifier code back to the central processing station 230 along with location information indicating to the central processing station 230 which RFID scanner 210 sent the identifier code. The sent location information may be actual location coordinates programmed into the RFID scanner, for example, or the sent location information may simply be an RFID scanner identifier which is correlated with location coordinates at the central processing station 230, for example.

The central processing station 230 uses the sent RFID tag identifier code and location information to track the individual throughout the domain 200. As a result, a plurality of individuals within the domain 200 may be tracked.

In accordance with an embodiment of the present invention, the central tracking station 230 includes at least one computer-based platform to operate on the acquired location information to accomplish the tracking, identifying, and correlating steps of the method 100.

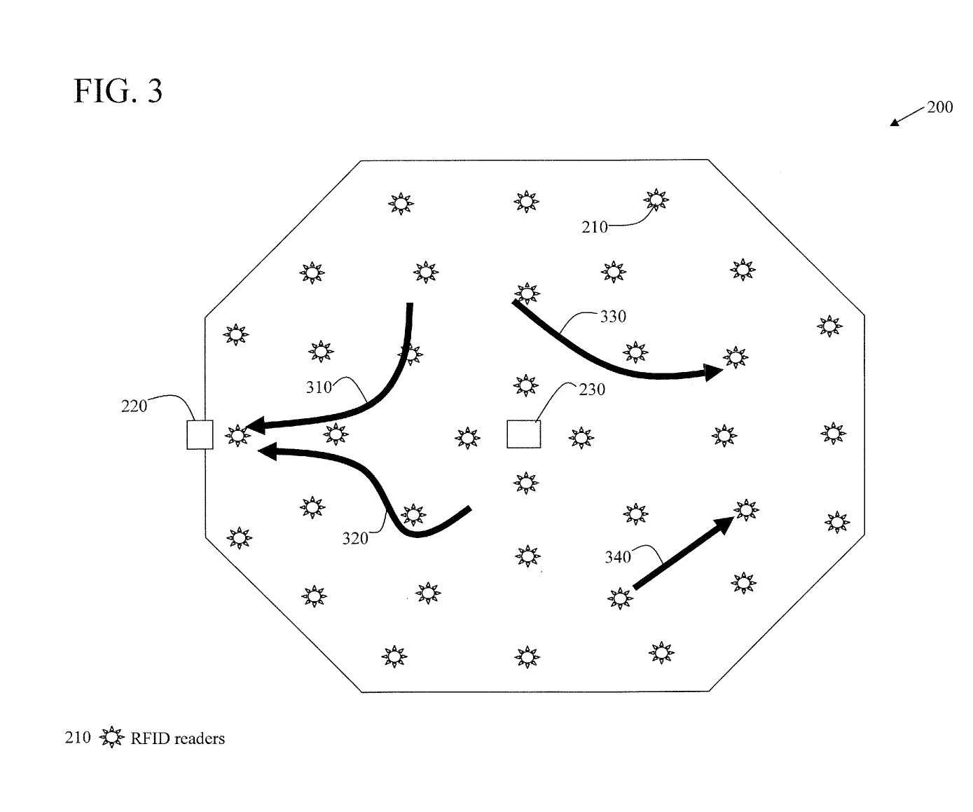

Continuing with the example, FIG. 3 is the diagram of FIG. 2 additionally illustrating exemplary identified traffic patterns of individuals, in accordance with the method 100 of FIG. 1. As individuals are tracked moving through the domain 200 (e.g., walking through a theme park), the central processing station 230 can identify traffic patterns created by the individuals moving through the domain 200 based on the location information. FIG. 3 shows two traffic patterns 310 and 320 of individuals moving toward the entrance/exit 220, for example, to leave the domain 200. FIG. 3 also shows two other traffic patterns 330 and 340 of individuals moving within the domain 200. The traffic pattern 330 may be a movement of tracked individuals towards restroom facilities, for example. The traffic pattern 340 may be a movement of other tracked individuals away from an amusement ride and toward a concession booth, for example.

By identifying the traffic patterns within the domain 200 at any given time, or over a period of time, at least one managed characteristic of the domain 200 can be adapted. Such a managed characteristic may be the re-location of employees throughout the domain 200 or a point-of-interest placement (e.g., a point-of-sale placement, a rest room, a vending machine) within the domain 200. For example, if the domain 200 is a theme park, the managers of the theme park could place mobile point-of-sale stations (e.g., hot dog vendors) along one of the identified traffic patterns. As a result, sales of hot dogs may be increased. As another example, the managers of the theme park could send employees of the theme park to follow the identified traffic patterns and pick up trash, knowing that individuals in motion along these identified traffic patterns are more likely to throw trash on the ground instead of waiting until they reach the next trash container.

As an alternative to RFID technology, GPS technology may be used to track the individuals within the domain 200. For example, each individual may be fitted with a GPS device upon entering the domain. As each individual moves through the domain, the GPS device co-located with (e.g., worn by) the individual receives GPS signals from GPS satellites and sends location information, along with an identifying code associated with that GPS device (and therefore with that individual), to the central processing station 230. Other tracking technologies may be employed instead, in accordance with various other embodiments of the present invention.

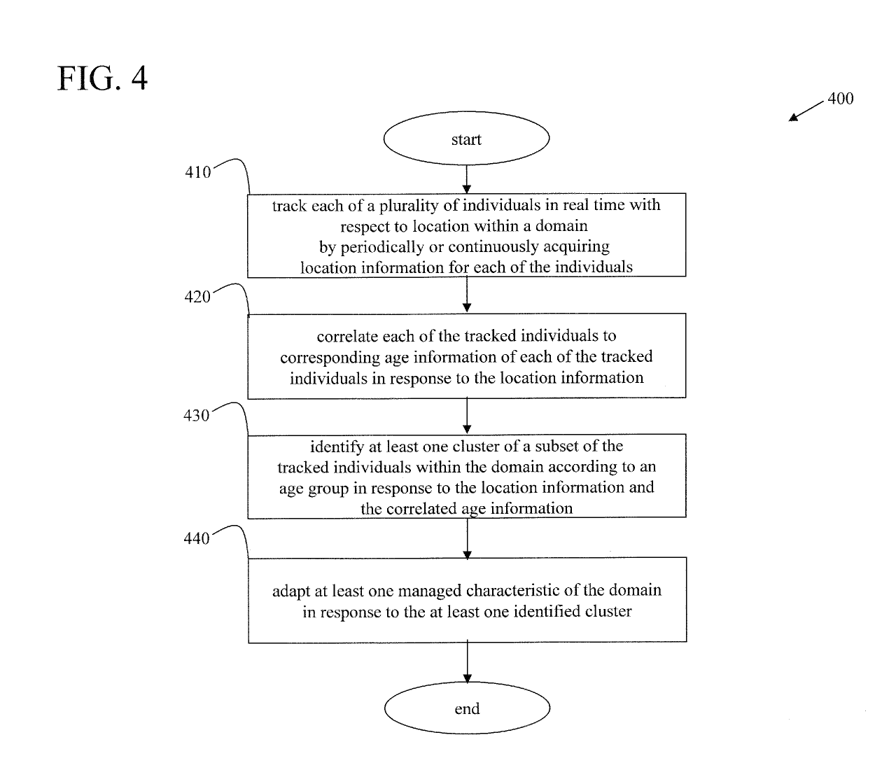

FIG. 4 is a flowchart of a second embodiment of a method 400 of managing at least one characteristic of a domain occupied by individuals, in accordance with various aspects of the present invention. In step 410, each of a plurality of individuals is tracked in real time with respect to location within a domain by periodically or continuously acquiring location information for each of the individuals. In step 420, each of the tracked individuals is correlated to corresponding age information of each of the tracked individuals in response to the acquired location information. In step 430, at least one cluster of a subset of the tracked individuals within the domain is identified according to an age group in response to the location information and the correlated age information. In step 440, at least one managed characteristic of the domain is adapted in response to the at least one identified cluster. For example, the managed characteristic may be an age-group-related service that is provided.

For example, when an individual enters the domain 200, the individual is given an RFID tag (e.g., in the form of a wrist band to put on) or a GPS device, and indicates their age (e.g., in years since birth) to a theme park employee handing out the RFID tags or GPS devices before or as the individual enters the domain 200. The employee enters the individual's age into a computer-based platform such that the individual's age is associated with (logically linked to) the RFID tag or GPS device provided to the individual. The associated information is sent to the central processing station 230 to be used for tracking purposes. Other factors such as, for example, the sex (male or female) of the individual may also be associated with the device provided to the individual, in accordance with various embodiments of the present invention.

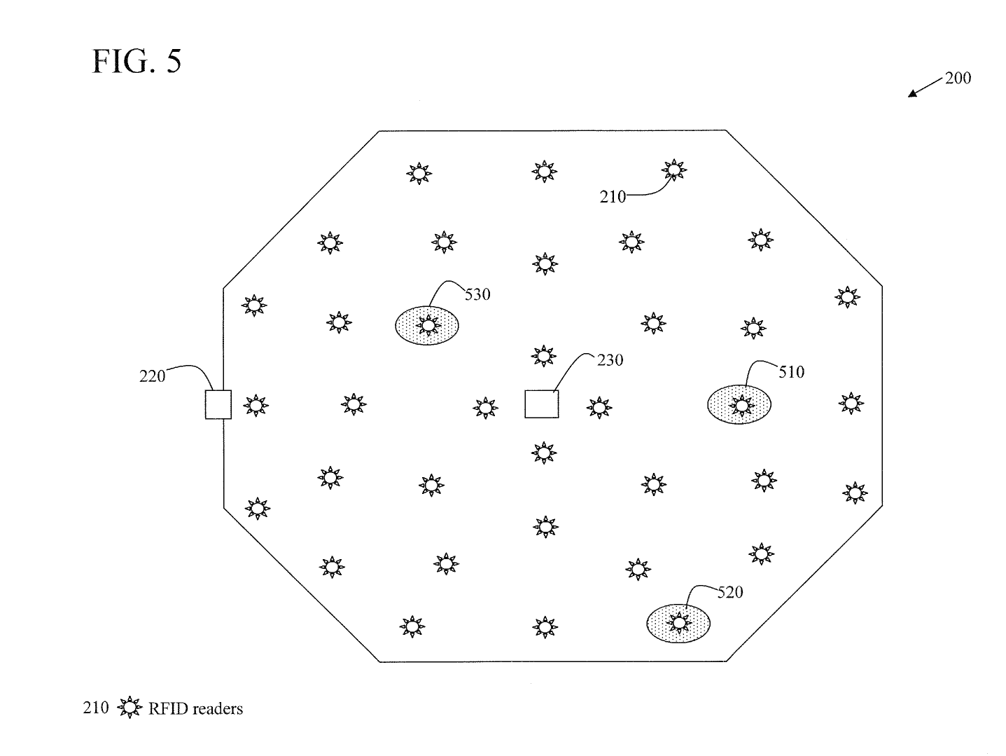

FIG. 5 is the diagram of FIG. 2 additionally illustrating exemplary identified clusters of individuals based on age, in accordance with the method 400 of FIG. 4. For example, as individuals are tracked within the domain 200, the central processing station 230 identifies a cluster 510 of individuals who mostly are in an age group of between 13 and 23 years of age. In response to identifying the cluster 510 of teenagers and young adults, the central processing station 230 adapts the type of music that is playing over the speakers in that part of the theme park domain 200 to correspond to the known musical tastes of that age group.

Continuing with the example, as individuals are tracked within the domain 200, the central processing station 230 also identifies a cluster 520 of individuals who are mostly within two age groups. The first age group is that of individuals under three years of age, and the second age group is that of individuals between 20 and 35 years of age. Such a cluster 520 likely corresponds to young children and their parents. In response to identifying the cluster 520 of young children and parents, the theme park management sends out an employee to the location of the identified cluster 520, with disposable diapers and diaper related products that may be provided to the parents if they are in need of such products.

Further continuing with the example, as individuals are tracked within the domain 200, the central processing station 230 also identifies a cluster 530 of individuals many of whom are between the ages of 55 and 75. Such a cluster 530 corresponds to senior citizens. The central processing station 230 also recognizes that the temperature within the theme park is above 85 degrees F. In response to identifying the cluster 530 of senior citizens on such a hot day, and knowing that senior citizens are susceptible to dehydration, the theme park management sends out an employee to the location of the identified cluster 530, with bottles of cold water to hand out to anyone who wants them.

In accordance with an embodiment of the present invention, the central tracking station 230 includes at least one computer-based platform to operate on at least the acquired location information to accomplish the tracking, correlating, and identifying steps of the method 400.

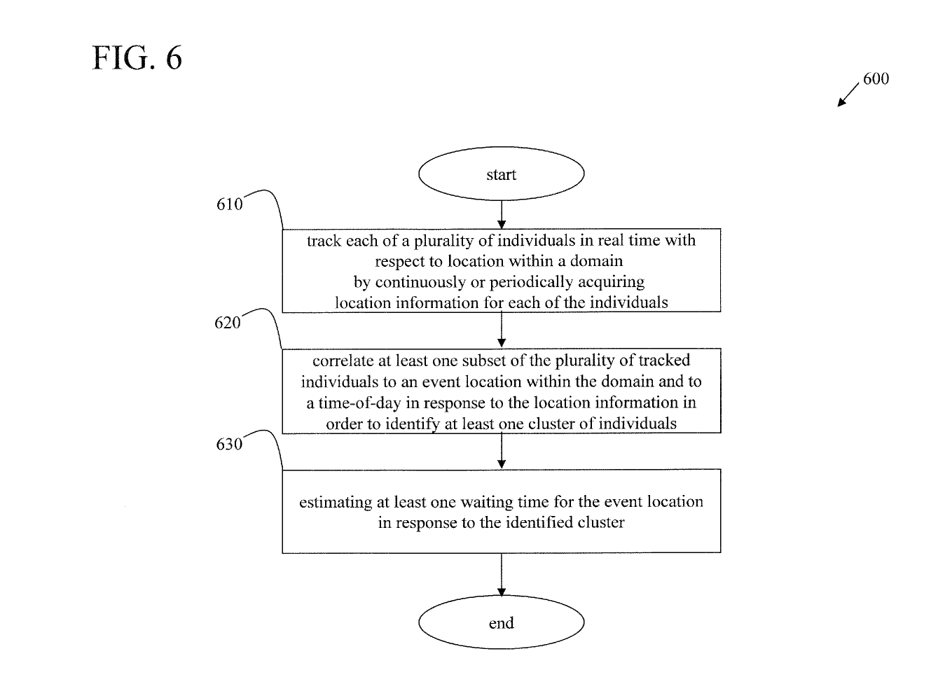

FIG. 6 is a flowchart of a third embodiment of a method 600 of managing at least one characteristic of a domain occupied by individuals, in accordance with various aspects of the present invention. In step 610, each of a plurality of individuals is tracked in real time within a domain by periodically or continuously acquiring location information for each of the individuals. In step 620, at least one subset of the plurality of tracked individuals is correlated to an event location within the domain and to at least one time-of-day in response to the acquired location information in order to identify at least one cluster of the individuals. In step 630, at least one waiting time is estimated for the event location in response to the identified cluster.

As an example, referring again to FIG. 5, the cluster 510 of mostly teenagers and young adults may be waiting in line to get on a popular theme park ride. The location of the ride is the event location. By identifying the cluster 510, according to the method 600, the central processing station 230 can estimate the waiting time for an individual entering the line for the ride based on the number of individuals in the cluster 510, and by knowing the number of individuals the ride can accommodate at a given time and the time duration of the ride. The estimated waiting time can be transmitted from the central processing station 230 to the ride where the estimated waiting time is then displayed such that the individuals entering the line can view the waiting time and decide whether or not they want to wait that long for the ride.

In accordance with an embodiment of the present invention, the central tracking station 230 includes at least one computer-based platform to operate on the acquired location information to accomplish the tracking, correlating, and estimating steps of the method 600.

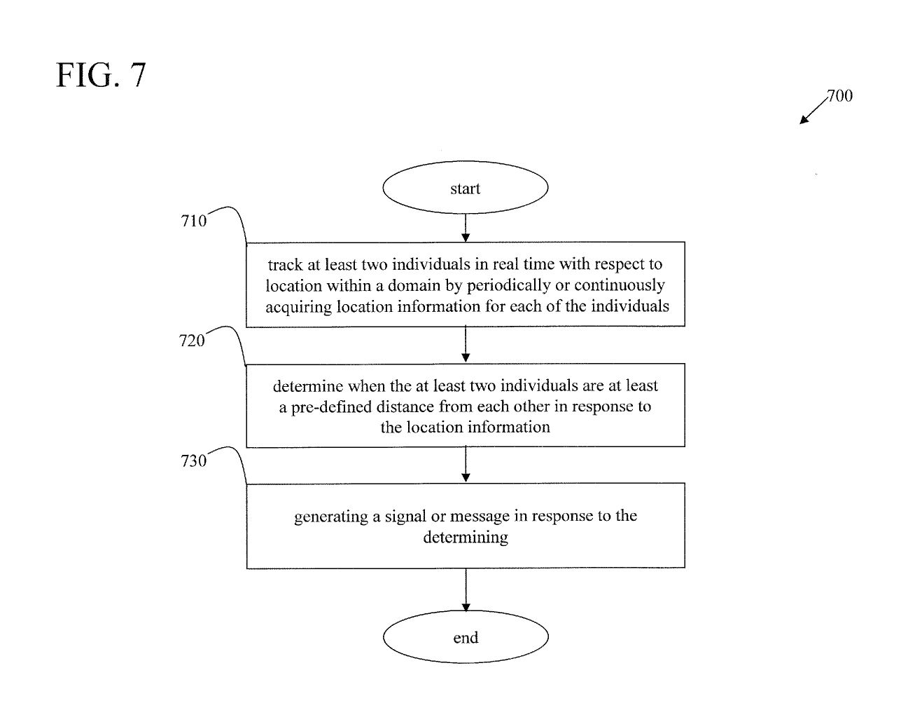

FIG. 7 is a flowchart of a fourth embodiment of a method 700 of managing at least one characteristic of a domain occupied by individuals, in accordance with various aspects of the present invention. In step 710, at least two individuals are tracked in real time with respect to location within a domain by continuously or periodically acquiring location information for each of the individuals. In step 720, a determination is made when the at least two individuals are at least a pre-defined distance from each other in response to the acquired location information. In step, 730 a signal or message (e.g., a warning signal) is generated in response to the determining step.

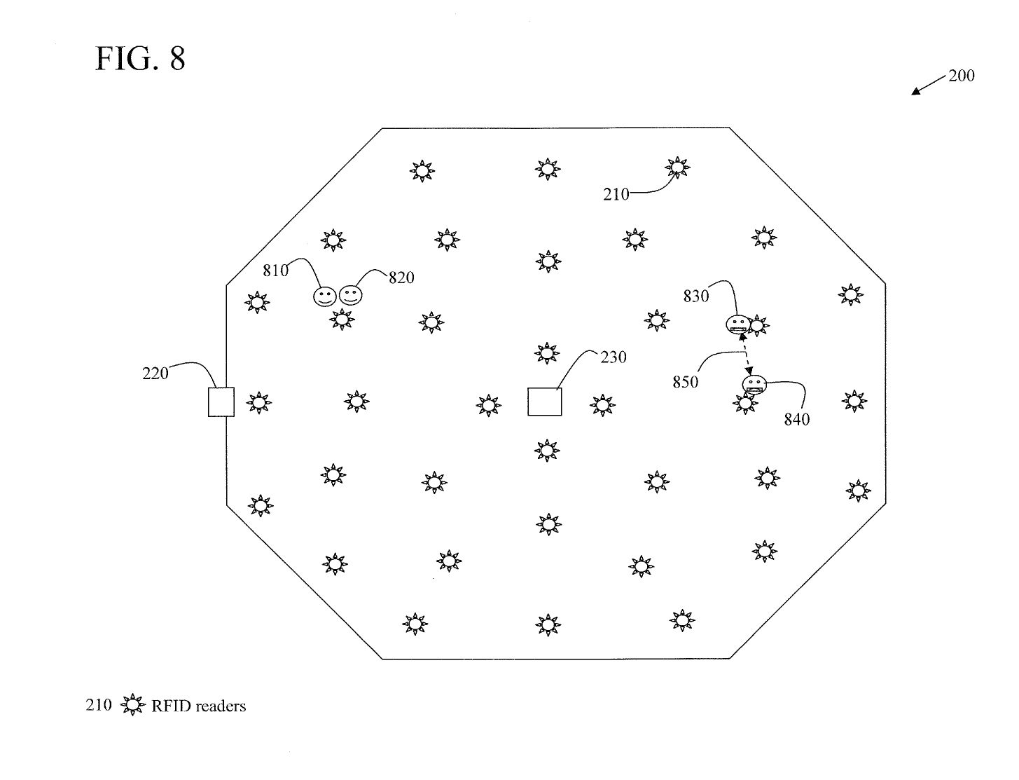

FIG. 8 is the diagram of FIG. 2 additionally illustrating exemplary spatially proximate and spatially remote individuals, in accordance with the method 700 of FIG. 7. For example, when two individuals enter the domain 200, their identification codes (based on their RF ID tags, GPS devices, or other tracking devices) are associated with each other (logically linked to each other) such that, while the individuals move about within the domain and are being tracked, the location information of the two individuals is being compared by the central processing station 230. The two individuals may be a parent and a child and it is desirable for the parent and the child to stay relatively close to each other within the domain 200 for safety reasons. If the two individuals (e.g., 810 and 820) are within a pre-defined distance (e.g., 50 feet) of each other, as determined by the central processing station 230, then conditions are considered normal. However, if the two individuals (e.g., 830 and 840) establish a distance 850 between each other that exceeds the pre-defined distance, then the central processing station 230 generates a warning signal or message. The warning signal or message (e.g., an email) may be received at a warning device co-located (e.g., worn by) the parent 830 such that the warning device generates an alert to the parent in response to the warning signal. The alert may include, for example, an audible sound or message, a flashing light, or a vibration given off by the warning device. As a result, the parent 830 can know when their child 840 has strayed (or has been taken) too far away from the parent 830.

The minimum discernable distance between any two tracked individuals may be determined by, for example, the spacing of the RFID scanners within the domain or the accuracy of the GPS device. In accordance with an alternative embodiment of the present invention, the child may also be fitted with a device to receive an audible message from the parent or from the central processing station 230 that tells the child to stay put, or to move to a particular location to be retrieved by the parent or an employee of the theme park, for example.

In accordance with an embodiment of the present invention, the central tracking station 230 includes at least one computer-based platform to operate on the acquired location information to accomplish the tracking, determining, and generating steps of the method 700.

In summary, certain embodiments of the present invention provide a systems and methods for managing at least one characteristic of a domain occupied by individuals. Individuals within the domain are tracked by acquiring location information and the resultant tracking information may be reacted to by adapting at least one managed characteristic of the domain.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiments disclosed, but that the invention will include all embodiments falling within the scope of the appended claims.

What is claimed is:

1. A method of managing at least one characteristic of a domain occupied by individuals, said method comprising:
tracking each of a plurality of individuals in real time with respect to location within a domain by periodically or continuously acquiring location information for each of said individuals;
identifying traffic patterns created by said plurality of tracked individuals within said domain in response to said acquired location information;
correlating each of said identified traffic patterns to at least one time-of-day; and
adapting at least one managed characteristic of said domain in response to at least one of said correlated traffic patterns.

2. The method of claim 1 wherein said domain comprises a theme park.

3. The method of claim 2 wherein said plurality of tracked individuals includes guests at said theme park.

4. The method of claim 1 wherein said at least one managed characteristic comprises point-of-interest placement within said domain.

5. The method of claim 1 wherein said tracking is accomplished using, in part, RFID technology.

6. The method of claim 1 wherein said tracking of any one of said individuals includes interrogating an RFID tag co-located with said individual and receiving at least an identification code from said RFID tag in response to said interrogating.

7. The method of claim 1 wherein said tracking is accomplished using, in part, GPS technology.

8. The method of claim 1 wherein said tracking of any one of said individuals includes generating said location information for said individual using a GPS device co-located with said individual and receiving at least said location information from said GPS device at a central processing station.

9. The method of claim 1 wherein said identifying and said correlating are accomplished using a computer-based platform operating on said acquired location information.

10. The method of claim 5 further comprising each of said plurality of individuals putting on a wrist band having an RFID tag which is unique to each of said individuals.

11. The method of claim 7 further comprising each of said plurality of individuals putting on a GPS device.

12. A method of managing at least one characteristic of a domain occupied by individuals, said method comprising:
tracking each of a plurality of individuals in real time with respect to location within a domain by periodically or continuously acquiring location information for each of said individuals;
correlating each of said tracked individuals to corresponding age information of each of said tracked individuals in response to said acquired location information;
identifying at least one cluster of a subset of said tracked individuals within said domain according to at least one age group in response to said location information and said correlated age information; and
adapting at least one managed characteristic of said domain in response to said at least one identified cluster.

13. The method of claim 12 wherein said domain comprises a theme park.

14. The method of claim 13 wherein said plurality of tracked individuals includes guests at said theme park.

15. The method of claim 12 wherein said at least one managed characteristic comprises providing at least one age-group-related service to said at least one cluster.

16. The method of claim 12 wherein said tracking is accomplished, in part, using RFID technology.

17. The method of claim 12 wherein said tracking of any one of said individuals includes interrogating an RFID tag co-located with said individual and receiving at least an identification code from said RFID tag in response to said interrogating.

18. The method of claim 12 wherein said tracking is accomplished, in part, using GPS technology.

19. The method of claim 12 wherein said tracking of any one of said individuals includes generating said location information for said individual using a GPS device co-located with said individual and receiving at least said location information from said GPS device at a central processing station.

20. The method of claim 12 wherein said correlating and said identifying are accomplished using a computer-based platform operating on said acquired location information.

21. The method of claim 16 further comprising each of said plurality of individuals putting on a wrist band having an RFID tag which is unique to each of said individuals.

22. The method of claim 18 further comprising each of said plurality of individuals putting on a GPS device.

23. The method of claim 20 further comprising entering an age of each of said plurality of individuals into said computer-based platform before or as each of said individuals first enters said domain.

24. A method of managing at least one characteristic of a domain occupied by individuals, said method comprising:
tracking each of a plurality of individuals in real time with respect to location within a domain by periodically or continuously acquiring location information for each of said individuals;
correlating at least one subset of said plurality of tracked individuals to an event location within said domain and to at least one time-of-day in response to said acquired location information in order to identify at least one cluster of said individuals; and
estimating at least one waiting time for said event location in response to said identified cluster.

25. The method of claim 24 wherein said domain comprises a theme park.

26. The method of claim 25 wherein said event location comprises a location of a theme park ride.

27. The method of claim 25 wherein said plurality of tracked individuals includes guests at said theme park.

28. The method of claim 24 wherein said tracking is accomplished, in part, using RFID technology.

29. The method of claim 24 wherein said tracking of any one of said individuals includes interrogating an RFID tag co-located with said individual and receiving at least an identification code from said RFID tag in response to said interrogating.

30. The method of claim 24 wherein said tracking is accomplished, in part, using GPS technology.

31. The method of claim 24 wherein said tracking of any one of said individuals includes generating said location information for said individual using a GPS device co-located with said individual and receiving at least said location information from said GPS device at a central processing station.

32. The method of claim 24 wherein said correlating and said estimating are accomplished using a computer-based platform operating on at least said acquired location information.

33. The method of claim 28 further comprising each of said plurality of individuals putting on a wrist band having an RFID tag which is unique to each of said individuals.

34. The method of claim 30 further comprising each of said plurality of individuals putting on a GPS device.

35. The method of claim 24 further comprising reporting said estimated waiting time for said event location to at least a subset of said plurality of individuals.

36. A method of managing at least one characteristic of a domain occupied by individuals, said method comprising:
tracking at least two individuals in real time with respect to location within a domain by periodically or continuously acquiring location information for each of said individuals;
determining when said at least two individuals are at least a pre-defined distance from each other in response to said acquired location information; and
generating a signal or message in response to said determining.

37. The method of claim 36 wherein said at least one managed characteristic comprises safety.

38. The method of claim 36 wherein said domain comprises a theme park.

39. The method of claim 38 wherein said plurality of tracked individuals includes guests at said theme park.

40. The method of claim 36 wherein said tracking is accomplished using, in part, RFID technology.

41. The method of claim 36 wherein said tracking of any one of said individuals includes interrogating an RFID tag co-located with said individual and receiving at least an identification code from said RFID tag in response to said interrogating.

42. The method of claim 36 wherein said tracking is accomplished using, in part, GPS technology.

43. The method of claim 36 wherein said tracking of any one of said individuals includes generating said location information for said individual using a GPS device co-located with said individual and receiving at least said location information from said GPS device at a central processing station.

44. The method of claim 36 wherein said determining and generating are accomplished, at least in part, using a computer-based platform operating on at least said acquired location information.

45. The method of claim 40 further comprising each of said plurality of individuals putting on a wrist band having an RFID tag which is unique to each of said individuals.

46. The method of claim 42 further comprising each of said plurality of individuals putting on a GPS device.

47. The method of claim 36 further comprising receiving said signal or message at a device co-located with at least one of said two tracked individuals such that said device generates an alert in response to said received signal.
